(19) United States
(12) Patent Application Publication
(10) Pub. No.: US 2005/0109463 A1
(43) Pub. Date: May 26, 2005

(54) Photo reactive thermal curing unit and apparatus therefor

(75) Inventor: Michael John Sellars, Mount Nasura (AU)

Correspondence Address: MCKEE, VOORHEES & SEASE, P.L.C., 801 GRAND AVENUE, SUITE 3200, DES MOINES, IA, 50309-2721, US

(73) Assignee: UV-Tek Products Limited, Flaxton (GB)

(21) Appl. No.: 10/960,146

(22) Filed: Oct. 7, 2004

(30) Foreign Application Priority Data
Oct. 7, 2003 (GB) 0323396.2
Dec. 3, 2003 (GB) 0327971.8
Dec. 17, 2003 (GB) 0329296.8

(51) Int. Cl. B31F 5/04; B27G 11/02; B32B 31/24; B44C 1/00

(52) U.S. Cl. 156/379.8; 156/379.9; 156/540; 156/380.9

(57) ABSTRACT

The invention relates to a curing unit for use integrally with, or attached to, further apparatus for the provision of for example, a photo reactive thermal laminator which allows the lamination of a substrate, typically in the form of a sheet material. In use the apparatus includes at least one curing lamp which emits UV light and through which the substrate with a transfer film placed thereon passes. The emitted light serves to cure the coating material of the transfer film and hence laminates the substrate. Protection is also claimed for the lamp configurations used.

### BACKGROUND OF THE INVENTION

The invention to which this application relates is to a photo reactive thermal curing unit and apparatus for the same which allows the curing unit, also referred to herein as a luminaire, to be used in the curing and/or reactance of material applied to a substrate and hence provide, for example, a UV coating/lamination for sheet material substrates which can be used for cold lamination when the curing unit is not active or hot lamination when the curing unit is active. The purpose of the curing and/or reaction is to change the condition of the material to a predetermined condition to meet subsequent usage requirements such as a UV coating for lamination of the substrate.

The provision of ultraviolet light and/or similar light emitting devices to provide for the curing of material is known. The advantages of providing a luminaire as a source of curing is that the same need not contact the material which is to be cured and therefore the surface of the material is not adversely affected by physical contact. Thus, the material which has been applied, perhaps to a pre-specified thickness, with a pre-specified surface smoothness or the like, may be maintained in that condition with respect to particular parameters as the curing of the same occurs. The curing effect is typically provided to cause a reaction of the material, either to change the physical condition of the same, or to provide a particular property to the material such as, for example, hardwearing characteristics.

However, problems are experienced and encountered with the use of curing luminaries in that the same may not provide the required curing effect sufficiently quickly from activation of the luminaire so as to allow the same to be adopted in a commercial coating process. Furthermore, the curing effect may not be uniform such that some areas of the material may be cured more quickly than others and this can lead to internal stresses and damage to the material during the coating process and difficulties in providing the required curing effect on sheet material which is fed past the curing station. Furthermore, the material which is applied to the substrate, can require different curing Wavelengths to be used depending on the chemical configuration of the material and the desired end effect. A yet further problem with existing equipment is that if the curing material is cured in aerobic conditions there is a need to provide high UV-C and UV B output from the lamp sources in order to cure the coating.

A further problem experienced is that typically the lamps which are used have two metal contact pins at either end, as has, for example, a standard fluorescent lamp. The contact pins allow electrical contact between the power supply sockets into which the lamp ends are engaged.

The problem with providing pins of this sort at each end is that the same are required to be relatively long so as to allow the same to be engaged and allow electrical connection in sockets which are provided. This therefore means that in order to accommodate the socket and the length of the pins, there is required to be provided an area of perhaps 4 to 5 cms at each side of the curing unit housing in which the lamp is located. These gaps at each side, means that while ultraviolet light emitted from the lamp may penetrate the areas underlying these gaps, the light does not penetrate as strongly as those areas which lie directly within the area defined by the UV light emitting part of the lamp itself. This therefore means that the curing effect on material or substances which lie under the end gaps may not be as quick and/or uniform with regard to the curing effect on the material or substance which lies in the main area of the curing lamp ultraviolet light emission. The provision of the gaps can also require that the housing in which the lamp is provided, is made wider but, in many instances, the housing cannot be made wider so that the emitting part of the lamp is made shorter. However as there is still required to be provided a uniform curing effect the present invention aims to provide a solution to this problem.

### SUMMARY OF THE INVENTION

A first aim of the present invention is to provide a curing unit which can be used to provide a curing effect in a uniform and efficient manner with regard to material and furthermore, to provide a curing unit which can be integrated as part of processing apparatus such as laminating apparatus and therefore act as an integral part of a coating and/or laminating procedure.

A further aim of the present invention is to provide a curing effect on material which ensures that uniform and efficient curing of the material can occur.

In a first aspect of the invention, there is provided a curing unit for providing a curing effect on a material which is placed within the curing range of the said unit and wherein the curing unit includes at least one lamp which provides UV-B and a broad UV-A light and near UV visible light ranging from 285 NM to 500 NM.

Preferably, the lamp generates little heat, outputs zero ionising and non-ionising UV-C and has relatively low UV-B levels. The benefit of this is that the lamp does not produce high output UV-C and UV-B and therefore does not need the provision of extraction systems and does not produce ozone as is conventionally the case.

Typically, the material to be cured is provided as a layer of a transfer film which is positioned between the lamp and the material to be cured thus making the material to be cured anaerobic and therefore allowing the curing to take place in a substantially inert environment with lower UV curing irradiance level required. In one embodiment the transfer film used can be Akzo Nobel Opti-set™ material.

Typically, the circuit for control and supply of electricity to the lamp is voltage seeking, low current and therefore operates with the majority of mains power supply values throughout the world. In one embodiment the lamp is provided in a form so as to be instantly, or substantially instantly, starting upon activation of the power supply. This means that as soon as the same is moved to an on condition, curing light of a sufficient level to cure the material is emitted. By providing an instant start feature, no warm-up time is required thereby improving the ability of the lamp to be incorporated into other apparatus and allowing the instant curing of the material.

In one embodiment, the curing unit includes one lamp or light source with an internal or external reflector to allow the reflection of light from the light source out through an aperture in front of which the material to be cured is positioned. The aperture may be open in one embodiment or alternatively closed by substantially transparent sheet material, typically of glass or plastics.

In one embodiment the lamps are designed specifically to produce correct UV-B-UV-A ratio, required by the coating and has a wide “doped” UV-A spectral output. The choice of phosphor and gasses within the lamp determines these values.

Typically, the visible light which is emitted from the lamp is pink or violet to reduce visible glare.

In one embodiment, the lamp can be provided with a film, or cover which prevents shattering of the glass to avoid glass fragments from the lamp from impinging on other apparatus such has rubber rollers, circuits with which the luminaire is associated.

In one embodiment, the curing unit or luminaire includes a plurality of lamps. In one specific embodiment a first elongate lamp is provided which extends substantially across the curing unit housing and at least one, but more typically both ends of the said lamp there is mounted a further lamp. In one embodiment the said further lamps can be positioned in line with the ends but positioned before or after the main lamp in terms of the direction of movement of the substrate which is being cured. This means that curing light can be directed onto material positioned in the areas of the substrate which pass under or above the ends of the elongate lamp which, without the additional lamps provided, would not otherwise be cured because of the end caps on the main lamp and insufficient curing light intensity at that position.

In one embodiment the additional lamps provided at the ends of the elongate lamp are U shaped.

In one embodiment all, but particularly the lamps provided at the ends can be cathodeless lamps to maximise output across the length of the lamp.

The arrangement of the curing unit in which a plurality of lamps are provided is particularly attractive in those instances where the curing unit is to be retrofitted as part of existing apparatus such as a standard hot or cold laminator, through which the material in a sheet material form fed as a cut sheet or from a roll, and typically laminated to a substrate passes. In this type of apparatus, the available width between, the sides of the apparatus and the edges of the sheet material are relatively small. The arrangement of the multiple cathode or cathodeless lamps allows the curing light to be emitted onto the sheet material and across the width of the same while ensuring that the curing unit can be accommodated into the apparatus.

In one embodiment the curing unit in accordance with the invention is used to provide a curing effect on a material in the form of a hot melt photo reactive coating provided as part of the transfer film. In one embodiment the transfer film is applied to a substrate in the form of sheet material. The transfer film comprises the material to be cured and a backing layer.

Once applied together, the substrate and the transfer film pass the curing unit and the curing light passes through the backing layer of the transfer film and cures the material to the substrate. Once cured, the backing layer of the transfer film can be removed leaving the cured material and the substrate.

In one embodiment the apparatus as a whole, and including the curing unit in accordance with the invention, allows the application of the transfer film hot melt photo reactive coating onto a light transmitting substrate. The transfer film can be wound on a core or fed as a single sheet and fed through a coating station at which the transfer film is applied to the substrate. In one embodiment, if wound, the feed rollers on which the transfer film is mounted are heated so as to soften the coating. The transfer film is then pressed onto paper, card or other substrate whereupon the same is passed to a curing unit with the lamp or lamps in accordance with the invention.

In one embodiment the transfer film is of a tack type with a silicon based backing layer. In this case heated rollers need not be provided so, for example, the transfer film can be cut to a required size and passed to a feed means to allow the same to be placed onto the substrate prior to the curing.

In a further embodiment of the invention the curing unit can include a lamp or lamps mounted so as to provide a first curing light directed onto a first surface of the substrate and a second curing light onto an opposing surface of said substrate thereby allowing material on both sides of the substrate to be cured simultaneously. In one embodiment the first and second curing lights are provided by suitably mounted first and second lamps. Alternatively, and particularly where the apparatus is relatively small in size the first and second curing lights can be provided by a single U shaped lamp with the sheet material to be cured passing between the limbs of the lamp.

In one embodiment, the curing unit is provided as part of apparatus which includes feed means and coating means as required. Alternatively the curing unit can be provided as an independent item of apparatus which can be used independently or in conjunction with other apparatus as required. In this embodiment it is envisaged that the same is suitable for domestic or small office use and in connection with or controlled by a Personal Computer, printer, laminator or photocopier to provide a coating facility for substrates such as leaflets, publicity material or photographic matter printed to the substrate.

The operation of the lamps can be continuous for as long as required with the same being controlled for example, by a sensor such as a photo cell which detects when the material to be cured is present and passes a particular location. The lamp can be controlled in response to microprocessor control means for the apparatus to which the curing unit is connected. For example the lamp can be switched on when the substrate to be cured passes a particular location on the apparatus with which the curing unit is provided In one embodiment the lamp which is used can be housed within a housing in the curing unit which is of greater width than the main housing of the curing unit thereby ensuring that the curing light is emitted across the width of the sheet material.

In one embodiment the lamps of the curing unit are provided to be movable between an in use position with respect to the substrate and a position removed from the substrate to allow the introduction of a new sheet material and/or joining together of sheet material edges, whereupon the lamps can be repositioned in the in use position. Typically in the raised position no power is provided to the lamps.

In a further aspect of the invention there is provided a curing unit for applying a curing effect on a material which is placed within the curing range of the said unit, said curing unit including a plurality of lamps to provide UV-B, broad UV-A light and UV visible light onto the said material and wherein said curing unit comprises a plurality of lamp units at least one of which is of a non-linear shape.

In one embodiment, the lamps are formed from an elongate tube provided in a geometrical shape. In one embodiment at least one of the lamps in the curing unit has a tube which is formed into a substantially circular shape. Preferably, all of the lamps in the curing unit are formed with the tube formed into a substantially circular shape. By circular is meant that the elongate tube is formed into a circular configuration with the ends of the tube is adjacent or abutting one another, typically at the power supply contact location. Typically, the lamps are provided in a row with the longitudinal axis of said row perpendicular to the direction of travel of the material which is to be cured through the curing unit.

In one embodiment, first and second, spaced, rows of lamps can be provided to allow the material to pass between said first and second rows so as to allow a curing effect to be applied by a first row onto a first surface of said material and a curing effect to be provided by the second row onto the opposing surface of said material simultaneously.

Typically, the irradiation emitted from the lamps in the circular configuration, is sufficient to ensure that a curing effect can be provided across the width of the material to be cured in a substantially uniform manner so as to provide a uniform curing effect or a uniform curing effect within given parameters, on the material.

In a yet further aspect of the invention there is provided a lamp and holder assembly for emitting light therefrom when electrically connected, said lamp having a first end with first and second metal contact pins and a second distal end with first and second metal contact pins and wherein, each of the metal contact pins has a wire connection thereto and wherein each of the wires terminates at a common contact location provided in a holder for said lamp to make electrical contact with the lamp.

Typically, each of the pins in the lamp are of a length than no more than 5mm which is significantly less than the conventional metal contact pin length.

In one embodiment, the wires are soldered to the respective metal contact pins. Typically, the holder for the lamp, includes a contact location towards one end of the same so that the wires from one end of the lamp are shorter than the wires from the other end of the lamp, with the free ends of all of the said wires terminating at a contact block at said contact location.

By providing the wires in contact with the metal contact pins, then firstly, the pins can be made shorter as the same are not required to be located in sockets with a twisting action but rather can simply be placed in a locating means at each end which does not require electrical contact means to be provided therein and this therefore significantly reduces the gap which is required to be left at each end of the lamp in the housing unit. This in turn means that the ultraviolet light which is emitted from the lamp portion is emitted uniformly across the entire length of the housing.

In one embodiment, the contact block which is used is a G10q lamp holder.

Typically, the housing is provided in a form such that when the lamp is located therein, ultraviolet light which is emitted from the lamp towards the housing is prevented from passing beyond the housing and therefore provides a masking effect to prevent ultraviolet light curing substances or materials which are not desired to be cured.

In a further aspect of the invention there is provided a photo reactive thermal laminator, said laminator including feed means to allow a substrate which is to be laminated to be fed through the apparatus, a transfer film including a curable material layer which is placed onto the surface of the substrate which is to be laminated, and a curing unit, said curing unit having at least one lamp provided to emit an ultraviolet curing light and wherein said feed means are provided to move the substrate, with the transfer film thereon, through the curing light and cause the curing of the said curable material layer to laminate the substrate.

Typically the laminator is roll fed or sheet fed.

In one embodiment the curing unit can be retrofitted to an existing laminator and thereby allows the laminator to be adapted to be used a cold and hot laminator.

### BRIEF DESCRIPTION OF THE DRAWINGS

Specific embodiments of the invention is now described with reference to the accompanying drawings wherein;

FIG. 1 illustrates a specific embodiment of a curing unit in accordance with one embodiment of the invention, as viewed from the underside.

FIG. 2 illustrates a schematic view of one embodiment of apparatus with which the curing unit of FIG. 1 can be incorporated.

FIG. 3 illustrates a schematic view of one embodiment of the invention.

FIG. 4 illustrates a further embodiment of the invention.

FIG. 5 illustrates a conventional lamp arrangement.

FIG. 6 illustrates a lamp arrangement in accordance with one embodiment of the invention.

FIG. 7 illustrates a housing for a lamp in accordance with the invention.

FIG. 8 illustrates an arrangement of housings in accordance with one embodiment of the invention.

### DETAILED DESCRIPTION OF THE PREFERRED EMBODIMENT

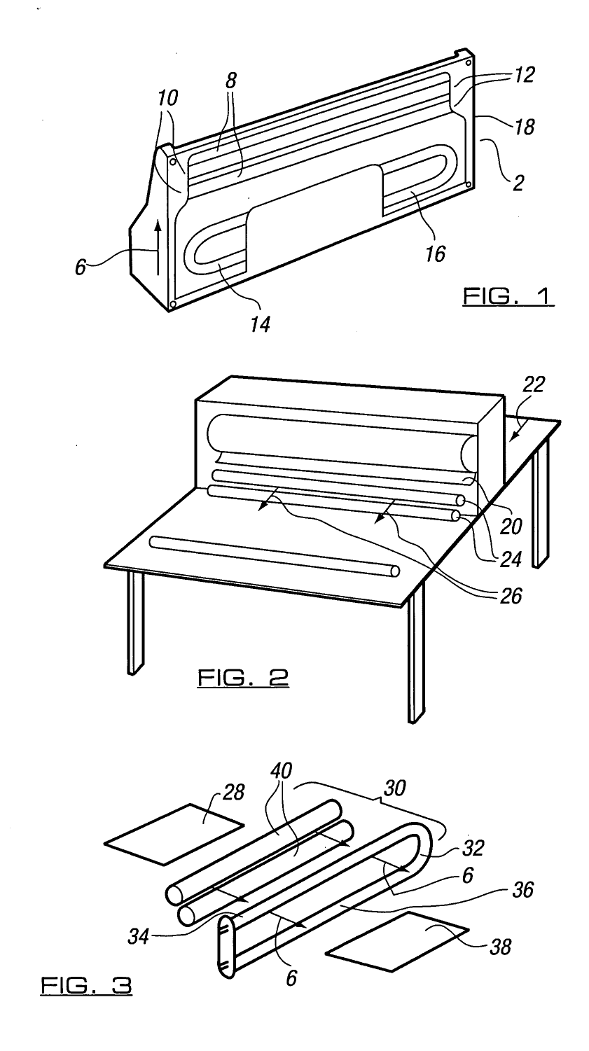

Referring to FIG. 1-3 there is illustrated a curing unit 2 in accordance with the invention. The curing unit is provided for directing curing light towards a sheet 4 which passes through the unit along a linear path illustrated by the arrow 6.

In FIG. 1 the curing light is provided from elongate lamps 8 which have end cap connections 10,12 and, located in line with the end cap locations 10, 12 but positioned in front of the same are further lamps 14,16 each of which is U-shaped as shown. All of the lamps are connected to a power supply control circuit (not shown) and the application of the power supply control circuit is controlled to allow a relatively quick start or power up of the lamps to instantly be in a curing mode. Thus the control circuit is designed to ensure the excitation of the internal components of the lamps to provide the instant or relatively quick curing effect.

The unit is also provided with a housing 18 within which the lamps are located. The inside of the housing can be designed and shaped to allow the optimum reflection of light towards the substrate. Alternatively or in addition each of the lamps can be provided with reflective formations around the same.

FIG. 2 illustrates one form of apparatus to which the curing unit in accordance with the invention can be attached or integrated to form the photo reactive thermal laminator. The apparatus is for applying a transfer film 20 onto a substrate 22. The substrate 22 which may for example have printed material thereon which is to be protected and the appearance enhanced, is fed through the apparatus and, as it passes through the same, the transfer film 20 which comprises a layer of material such as a UV coating with a backing layer, is applied to the substrate 22 to coat a surface of the same. The rollers 24 through which the transfer film passes can be heated so as to soften the coating material of the transfer film prior to application to the substrate and to aid the adherence of the same. Once applied, the substrate with the transfer film pass as illustrated by arrows 26 through the curing unit whereupon the curing light passes through the backing layer of the transfer film and cures the curable material to adhere the same to the substrate and hence provide the lamination.

The apparatus of FIG. 2 is most suited to industrial or commercial graphic arts establishments. FIG. 3 illustrates a schematic view of a further embodiment of apparatus wherein the same is provided, for example for use in a desktop format and the apparatus may, for example, be PC controlled or compatible therewith and is therefore suitable for home or small office use. This allows the use of reduced quality papers, which has cost and environmental benefits, which can then be printed and coated using the apparatus and then act as a protective and visual enhancement layer. In this case the transfer film layer is again applied to the printed substrate to form the sheet material 28. The material passes to the curing unit 30, this time incorporating a U shaped lamp 32. The sheet material passes between the limbs 34, 36 of the lamp and cures the material to form the coated substrate 38. Thus in this arrangement, if required, a coating layer can be applied to both sides of the substrate. In this form it is envisaged that the substrate will be in the form of a sheet of paper rather than a roll and in one embodiment the curing unit can be incorporated as part of, for example, a photocopier, laminator or printer. If required, heated rollers 40 can be provided but, in certain instances may not be necessary, depending on the form of transfer film used.

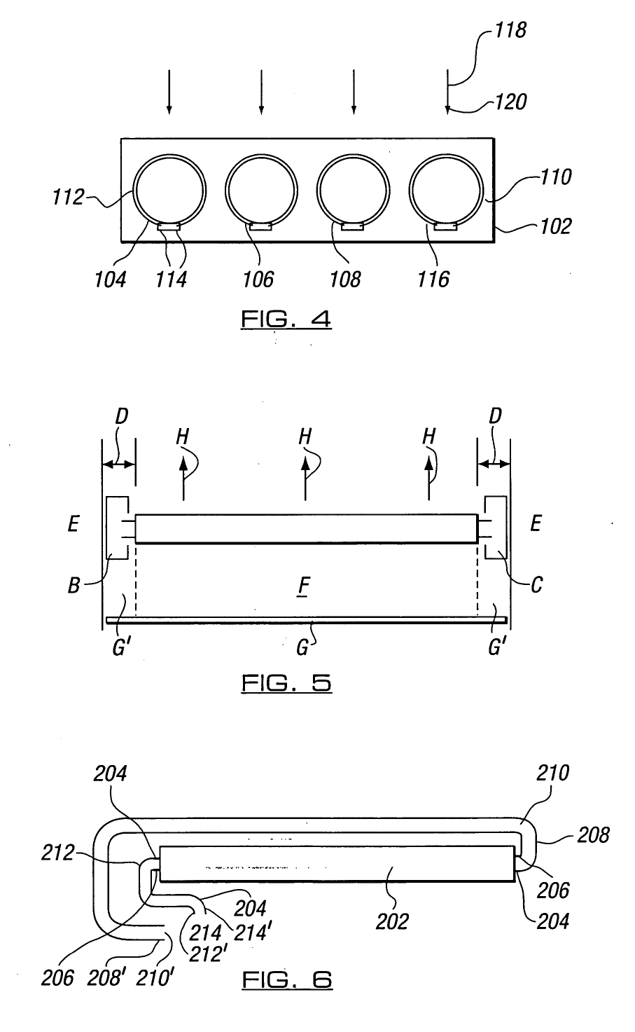

FIG. 4 illustrates a curing unit 102 in accordance with another embodiment of the invention in plan view. In this embodiment, the curing unit comprises four lamps 104, 106, 108 and 110. Each of the lamps comprises an elongate tube from which a curing light is emitted, when powered, with the ends of the tube 114 abutting one another at the power contact through which power can be supplied to illuminate the tube. When illuminated, ultraviolet curing light is emitted outwardly therefrom. A relatively low irradiance is emitted from the tube at the contact location 116 but sufficient irradiance is emitted from the remainder of the lamp so as to extend downwardly and to the sides of the lamp both towards the centre of the circular lamp configuration and away from the lamp towards adjacent lamps and/or the sides of the curing unit.

The spacing of the lamp units both from the edge of the curing unit and between each other, is determined so as to ensure that the irradiance which is emitted from each of the lamps extends into and through the spaces between the lamps towards the sheet material intended to be cured so as to ensure that the curing light which is applied to the sheet material 118 which is moving in the direction indicated by arrows 120 through the curing unit 102, is sufficient to provide a uniform curing effect across the sheet material as it passes through the curing unit. Obviously, the distance of the sheet material from the curing unit is also important when deciding upon the spacing of the lamp units.

By providing the lamp units with a circular tube configuration as shown, so the need to provide two different forms of lamp units is avoided, as the circular lamp units alone allow the uniform curing effect to be achieved.

This has advantages in storage in that only one particular form of lamp unit is required to be stored, in manufacture in that a uniform single form of lamp unit can be formed and used and it is also found that the circular configuration of the lamp unit makes the same easier to utilise and the relative spacings of the same to be more easily calculated to ensure that the uniform curing effect on the material is achieved.

Although not shown, the curing unit can include more than one row of the lamps so as to provide a curing effect on opposing sides of sheet material passing between the rows of lamps. Typically the curing unit is provided as an integral part of a photo reactive thermal laminator.

Referring now to FIG. 5, there is illustrated a conventional curing lamp A with electrical contact sockets B, C, which act as mechanical location means as well as electrical contacts. It will be seen that in this conventional arrangement, a significant gap D is required to be left between the end of the lamp body and the housing E on which the electrical contact sockets are provided. This therefore means that the substance G which is to be cured which lies under the lamp, does not receive ultraviolet light to the same strength on those portions G′ lying under the gaps D than the substance G lying within the area F in which most of the ultraviolet light from the lamp is emitted.

A further problem with the conventional system is that ultraviolet light is emitted around 360° from the lamp and therefore can be also emitted in the direction H which may cause a curing effect of substances which are not desired to be cured such as, for example, a transfer film.

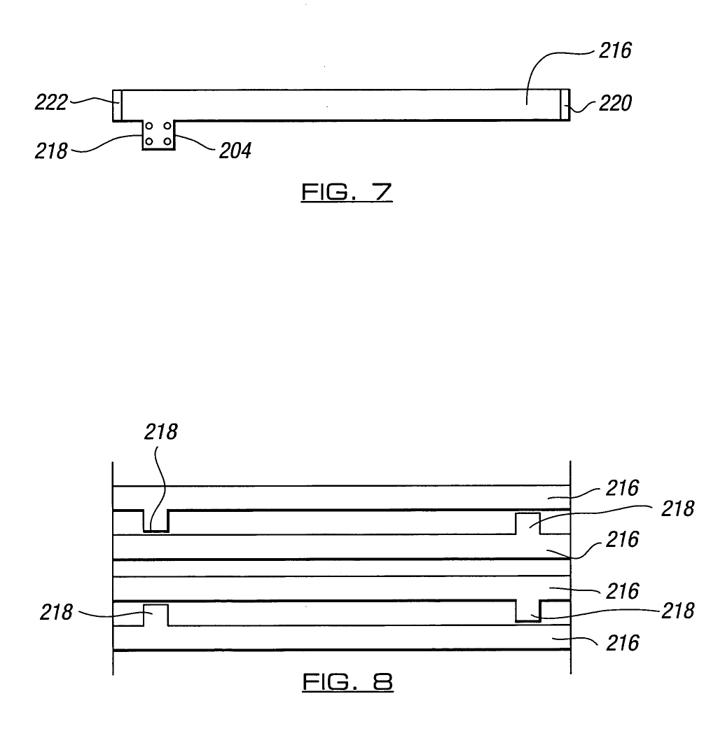

FIGS. 6-8 illustrate an arrangement of a lamp 202 in accordance with this aspect of the invention. In this arrangement, the lamp 202 is again provided with contact pins 204 and 206 at each end but the same, rather than being the conventional length of 8 mm are shortened to 3 mm. Furthermore, no contact sockets are required to be provided in the housing for each end of the lamp but rather the contact pins 204, 206 are each connected to one of the wires 208, 210, 212, 214 as shown, typically by soldering. The free ends of the wires 208′, 210′, 212′, 214′ are brought towards a common location for engagement with a holder 216 as shown in FIG. 7 and in particular a contact block 218 which has four contacts for reception of each of the free ends of the wires 208′, 210′, 212′, 214′. Thus, the holder 216 acts to receive the lamp and mechanically locate the lamp in position as typically the holder includes a push fit arrangement at one or both ends 220, 222 but this push fit arrangement is only required to receive and mechanically locate the ends of the lamp and no electrical means are required to be provided which therefore greatly reduces the gap required to be provided between the end of each lamp and the housing. In turn, this allows the ultraviolet light which is emitted from the lamp to be emitted substantially uniformly across the width of the housing which, in turn means that the curing effect on the substances below the lamp is uniform and there is no problem with the tailing off of the curing effect towards the edges of the substance.

The ability to locate the lamp in the holder by a push fit arrangement rather than a twist arrangement as in the conventional case which requires finger space on both sides to allow rotation of the lamp unit, means that much less of a gap is required to be provided at each end of the lamp. This therefore allows three to four lamps to be inserted into the luminaire with the space which is available. Furthermore, by offsetting the electrical contact block 218, the lamp can be extended to the maximum available width of the housing which pushes the UV curing width closer to the sides of the housing and therefore enables greater cure width than with a standard or conventional lamp with the end fitting arrangements.

Typically the holder is made of moulded plastic and the lamp is inserted into the housing. Another advantage is that with the holder extending across the length of the lamp, this means that the holder provides a masking effect thereby preventing the ultraviolet curing light from passing through the holder or beyond the same and therefore ensuring that the ultraviolet light can be directed in the direction required with regard to the substance which is to be cured.

There is therefore provided a curing unit which can be used independently or as an integral part, possibly by retrofitting, of a laminating apparatus and thereby allow the provision of an ultraviolet curing effect to be created on a curable material.

1. A curing unit for providing a curing effect on a material which is placed within the curing range of the said unit and wherein the curing unit includes at least one lamp which provides UV-B and a broad UV-A light and near UV visible light ranging from 285 NM to 500 NM.

2. A curing unit according to claim 1 wherein the at least one lamp outputs zero ionising and non-ionising UV-C.

3. A curing unit according to claim 2 wherein the at least one lamp does not produce ozone when operated.

4. A curing unit according to claim 2 wherein the at least one lamp is operable without the provision of extraction means for the surrounding environment.

5. A curing unit according to claim 1 wherein the material to be cured is covered by a transfer film which is positioned between the lamp and the material to be cured.

6. A curing unit according to claim 5 wherein the transfer film renders the material to be cured anaerobic.

7. A curing unit according to claim 1 wherein the lamp is substantially instantly starting upon activation of the power supply.

8. A curing unit according to claim 1 wherein the at least one lamp is provided with a reflector to allow the reflection of light from the light source out through an aperture in front of which the material to be cured is positioned.

9. A curing unit according to claim 1 wherein the at least one lamp has a predefined UV-B-UV-A ratio to suit the material to be cured and has a wide “doped” UV-A spectral output.

10. A curing unit according to claim 1 wherein the at least one lamp is provided with a film, or cover to prevent glass fragments from the lamp from impinging on other apparatus, upon breakage.

11. A curing unit according to claim 1 wherein the curing unit includes a first elongate lamp extends substantially across the curing unit housing and at least one end of the said lamp there is mounted a further lamp.

12. A curing unit according to claim 11 wherein the at least one further lamp is offset from the elongate lamp in terms of the direction of movement of the substrate which is being cured.

13. A curing unit according to claim 11 wherein the at least one further lamp is U shaped.

14. A curing unit according to claim 1 wherein the at least one lamp used is cathodeless.

15. A curing unit according to claim 1 wherein the curing unit is provided to be retrofitted to apparatus through which the substrate to be laminated by the cured material, passes.

16. A curing unit according to claim 15 wherein the length of the area over which the curing light is emitted at least matches the width of the apparatus through which the substrate passes.

17. A curing unit according to claim 1 wherein the curing unit provides a curing effect on a material in the form of a transfer film hot melt photo reactive coating.

18. A curing unit according to claim 17 wherein the transfer film comprises the material to be cured and a backing layer.

19. A curing unit according to claim 18 wherein once applied together, the substrate and the transfer film pass through the curing unit and the curing light emitted passes through the backing layer of the transfer film and cures the material to the substrate.

20. A curing unit according to claim 19 wherein once cured, the backing layer of the transfer film is removed to leave the cured material and the substrate.

21. A curing unit according to claim 18 wherein the transfer film is fed through a coating station at which the transfer film is applied to the substrate prior to passing through the curing light.

22. A curing unit according to claim 21 wherein heating means are provided to heat the transfer film prior to application to the substrate.

23. A curing unit according to claim 21 wherein the transfer film is of a tack type with a silicon based backing layer.

24. A curing unit according to claim 1 wherein the curing unit includes a lamp or lamps mounted so as to provide a first curing light directed onto a first surface of the substrate and a second curing light onto an opposing surface of said substrate thereby allowing material on both sides of the substrate to be cured simultaneously.

25. A curing unit according to claim 24 wherein first and second curing lights are provided by suitably mounted first and second lamps on respective sides of the substrate.

26. A curing unit according to claim 24 wherein a U shaped lamp is used with the substrate to be cured passing between the limbs of the lamp.

27. A curing unit according to claim 1 wherein the curing unit is provided as part of apparatus which includes feed means and coating means as required.

28. A curing unit for applying a curing effect on a material which is placed within the curing range of the said unit, said curing unit including a plurality of lamps to provide UV-B, broad UV-A light and UV visible light onto the said material and wherein said curing unit comprises a plurality of lamp units, at least one of which is of a non-linear shape.

29. A curing unit according to claim 28 wherein the lamps are formed from an elongate tube provided in a geometrical shape and at least one of the lamps in the curing unit has a tube which is formed into a substantially circular shape.

30. A curing unit according to claim 29 wherein all of the lamps in the curing unit are formed a substantially circular shape.

31. A curing unit according to claim 29 wherein the lamps are provided in a row with the longitudinal axis of said row perpendicular to the direction of travel of the substrate which is to be cured through the curing unit.

32. A curing unit according to claim 1 wherein the curing unit includes a holder and a lamp assembly for emitting light therefrom when electrically connected, said lamp having a first end with first and second metal contact pins and a second distal end with first and second metal contact pins and wherein, each of the metal contact pins has a wire connection thereto and wherein each of the wires terminates at a common contact location provided in a holder for said lamp to make electrical contact with the lamp.

33. A curing unit according to claim 32 wherein each of the pins in the lamp are of a length than no more than 5 mm.

34. A curing unit according to claim 32 wherein the holder for the lamp includes a contact location towards one end of the same so that the wires from one end of the lamp are shorter than the wires from the other end of the lamp, with the free ends of all of the said wires terminating at a contact block at said contact location.

35. A photo reactive thermal laminator, said laminator including feed means to allow a substrate which is to be laminated to be fed through the apparatus, a transfer film including a curable material layer which is placed onto the surface of the substrate which is to be laminated, and a curing unit, said curing unit having at least one lamp provided to emit an ultraviolet curing light and wherein said feed means are provided to move the substrate, with the transfer film thereon, through the curing light and cause the curing of the said curable material layer to laminate the substrate.

36. A photo reactive thermal laminator according to claim 35 wherein the curing unit is retrofitted to the laminator thereby allowing heated lamination to be performed.
